(19) United States
(12) Patent Application Publication
(10) Pub. No.: US 2022/0188906 A1
(43) Pub. Date: Jun. 16, 2022

(54) PREDICTIVE PRODUCT AVAILABILILTY FOR GROCERY DELIVERY

(71) Applicant: salesforce.com, inc., San Francisco, CA (US)

(72) Inventor: Robert Lacy, Burlington, MA (US)

(21) Appl. No.: 17/117,238

(22) Filed: Dec. 10, 2020

(51) Int. Cl. G06Q 30/06; G06N 20/00

(52) U.S. Cl. CPC G06Q 30/0635; G06Q 30/0641; G06N 20/00; G06Q 30/0639

(57) ABSTRACT

Methods, computer readable media, and devices for predictive product availability for grocery delivery are presented. A method may include determining a shopping location and a future delivery window. A predicted availability of one or more grocery product items may be generated based on the location and delivery window. If the predicted availability of the items exceeds a threshold, the items may be presented to a user for selection as part of an order. If the predicted availability of the items does not exceed a threshold, alternative shopping locations and/or alternative future delivery windows may be presented to the user for selection. A machine learning algorithm may be implemented to generate the predicted availability of the one or more grocery product items, the one or more alternative shopping locations, and/or the one or more future delivery windows.

### TECHNICAL FIELD

One or more implementations relate to the field of predictive product availability for grocery delivery; and more specifically, to the predicted availability of one or more grocery product items corresponding to one or more shopping locations and one or more future delivery windows.

### BACKGROUND

Current grocery delivery options allow an individual to select grocery items from a selected location for future delivery. However, those options utilize inventory of the selected location that is current as of the time a user places the order. As a result, when the selected location attempts to fulfill the order in the future, the location may not be able to successfully fulfill the order. For example, one or more of the grocery items in the order may no longer be available or there may be an insufficient quantity. In this example, one or more substitutions may be made and these substitutions may have a negative impact.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description explain the principles of implementations of the disclosed subject matter. No attempt is made to show structural details in more detail than can be necessary for a fundamental understanding of the disclosed subject matter and various ways in which it can be practiced.

FIG. 1A is a block diagram illustrating a predictive product availability model according to some example implementations.

FIG. 1B is a block diagram illustrating a predictive product availability for grocery delivery system according to some example implementations.

FIG. 2A is a flow diagram illustrating a method for use with predictive product availability for grocery delivery according to some example implementations.

FIG. 2B is a flow diagram illustrating a method of generating predicted availability of grocery product items according to some example implementations.

FIG. 2C is a flow diagram illustrating a method of generating alternative shopping locations according to some example implementations.

FIG. 2D is a flow diagram illustrating a method of generating alternative future delivery windows according to some example implementations.

FIG. 3A is a block diagram illustrating an electronic device according to some example implementations.

FIG. 3B is a block diagram of a deployment environment according to some example implementations.

### DETAILED DESCRIPTION

Various aspects or features of this disclosure are described with reference to the drawings, wherein like reference numerals are used to refer to like elements throughout. In this specification, numerous details are set forth in order to provide a thorough understanding of this disclosure. It should be understood, however, that certain aspects of disclosure can be practiced without these specific details, or with other methods, components, materials, or the like. In other instances, well-known structures and devices are shown in block diagram form to facilitate describing the subject disclosure.

Implementations of the disclosed subject matter provide methods, computer readable media, and devices for predictive product availability for grocery delivery. Implementations of the disclosed subject matter may determine a selected shopping location and a selected future delivery window. Based on the selected shopping location and selected future delivery window, a predicted availability of one or more grocery product items may be generated. If the predicted availability of the one or more grocery items exceeds a threshold, the one or more grocery product items may be presented to a user for selection as part of a grocery delivery order. If the predicted availability of the one or more grocery product items does not exceed a threshold, one or more alternative shopping locations and/or one or more alternative future delivery windows may be presented to the user for selection. In some implementations, a machine learning algorithm may be implemented to generate the predicted availability of the one or more grocery product items, the one or more alternative shopping locations, and/or the one or more future delivery windows.

Traditional e-commerce is optimized for customers to browse and purchase products that are available for immediate sale and delivery. Traditional e-commerce typically results in a fulfillable order. A fulfillable order may be, for example, an order placed by a customer for a specific quantity of a specific item that is a) fulfilled when the order is placed (i.e., the ordered quantity of the product is shipped in full); b) partially fulfilled when the order is placed and completed at a future time (i.e., a smaller quantity of the product is shipped when ordered and the remaining quantity is shipped when available); c) fulfilled when the ordered quantity becomes available (i.e., a backordered product is shipped when back in stock); or d) fulfilled based on some other inventory management option. While there are a few exceptions (e.g., preorder, backordered items, etc.), the general process is designed to mimic a customer's shopping experience in a physical store with shelves full of products. In particular, inventory levels, promotions, and product recommendations are maintained in real time based on current activity.

The traditional e-commerce model does not map well to online grocery delivery where grocery items may not be retrieved from physical store shelves until some point in the future. A grocery delivery order, in contrast to a fulfillable order as discussed above, may be, for example, an order that is placed for delivery during a future delivery window from a selected shopping location. For example, a customer may prefer a grocery order to be delivered in two days (e.g., the customer places the order on Monday for delivery on Wednesday). In this example, a store clerk or other “shopper” may not physically retrieve selected grocery items from a store's shelves until two days after the order was placed. Meanwhile, other in person customers may also decide to purchase the same grocery items. As such, when the store clerk or other “shopper” does actually attempt to physically retrieve the selected grocery items, the selected grocery items may no longer be available or there may be insufficient quantities. In this example, the store clerk or other “shopper” may then need to substitute the selected grocery item with an alternate product. These substitutions may be made based on present rules and/or customer discretion and may be time consuming and/or suboptimal. In some cases the customer may not want the order to be completed with substitutions, or may not want the order placed at all if the specific items are not available at the selected time, or may want the order delivered earlier or later in order to receive the specific items.

There are other differences as well between the traditional e-commerce model and online grocery delivery. Many grocery items may be perishable or otherwise have a short shelve life and grocery stores may maintain smaller quantities with a higher turnover and resupply frequency. Many customers may be local, typically within 25 miles of the grocery store from which an order is placed. In addition, grocery stores often maintain a non-traditional supply chain in which grocery items are supplied from farms, fisheries, dairies, and other such sources that are subject to forces such as weather, climate, commodity prices, external shipping networks, and/or other issues.

In various implementations, a predictive product availability for grocery delivery system may utilize a model that generates a predicted availability of grocery items for a shopping location during a future grocery delivery window. In these implementations, grocery items may be presented to an online shopper as available or out-of-stock based on the generated predicted availability. This may provide a more accurate product listing and may reduce the need for last minute substitutions. These implementations may also provide search results that prefer or otherwise prioritize grocery items that are predicted to be in stock. In addition, implementations may enable product promotions based on predicted availability of grocery items. For example, a vendor may promote grocery items that may have a larger quantity at the time of the future delivery window and/or may be impacted by seasonal and/or cyclical factors. In addition, implementations may allow grocery item recommendations based on predicted availability of grocery items. For example, grocery items may be recommended based on both the time and date that an online customer places an order and the time and date of the future delivery window. In various implementations, the predictive product availability for grocery delivery system may distinguish from a conventional inventory management system that might order goods based on general expected demand. In various implementations, the predictive product availability system may operate in conjunction with conventional inventory management type systems.

In one example, a customer may place an online grocery order on Tuesday evening for delivery on Thursday between 9 am-11 am. As part of the order, the customer may select a physical store that is nearest the customer. The customer, in this example, may want to order fresh wild-caught salmon filets, which are typically available during the current season. While the salmon filets may be in stock at the time the order is placed (i.e., Tuesday evening), new deliveries may arrive at the store on Tuesdays, Thursdays, and Saturdays and inventory may often run out between deliveries. Based on this information, a predictive product availability model, for example, may determine that the salmon filets may not be available during the selected 9 am-11 am Thursday delivery window. In this example, an online shopping portal may provide the customer two alternative future delivery windows when the salmon filet are predicted to be available. Further in this example, one of the two alternative future delivery windows may include a $1/1b. promotional discount based on predicted availability of higher quantities for which the store may want to sell as much as possible of the perishable food.

In a further example, the online shopping portal may identify one or more alternative shopping locations for selection by the customer. For example, a predicted availability of the salmon filets may be generated for each of a number of alternative shopping locations and those locations with the largest predicted availability and/or with a predicted availability that exceeds a threshold may be presented for selection by the customer.

In various examples, after the customer has placed a number of grocery orders to provide a substantial history of product preferences, one or more delivery windows may be recommended to the customer such that predicted availability of the most shopped for items is maximized. In other examples, commerce analytics reporting may be expanded to include date and time of order and time and time of shopping as additional data points. In still other examples, the generated predicted product availability may be utilized to improve or otherwise modify supply chain and product availability.

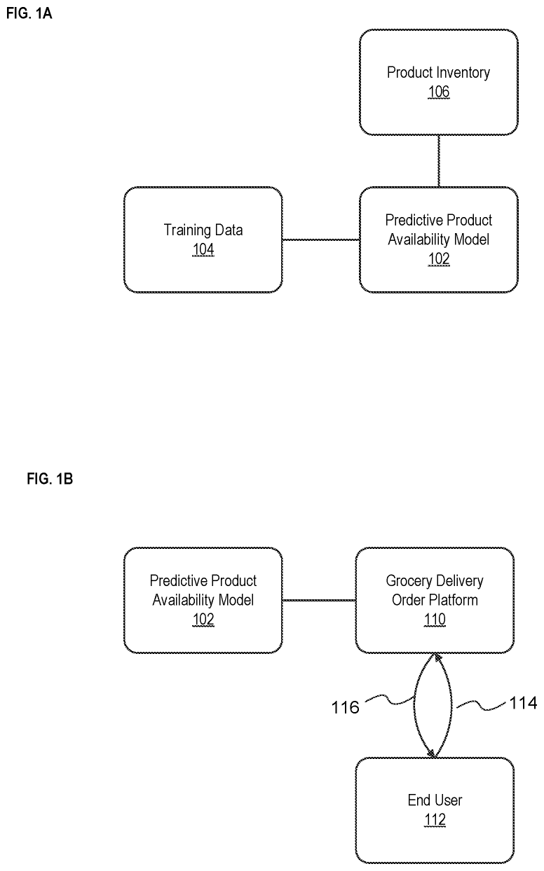

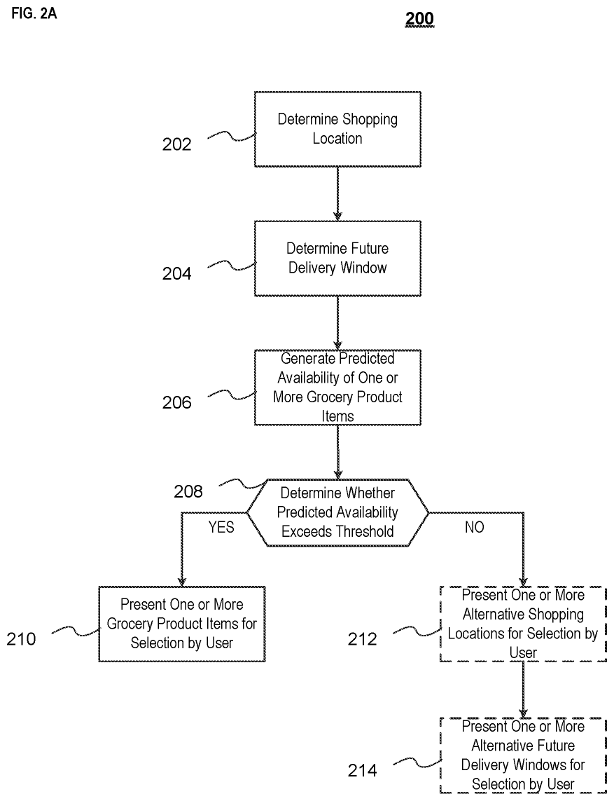

FIG. 1A illustrates a predictive product availability model 102 according to some example implementations. In various implementations, training data 104 may be provided to the predictive product availability model 102 in order to develop the model. In addition, product inventory 106 may also be provided to develop and improve the model. The predictive product availability model 102 may be, for example, a machine learning algorithm. In various implementations, the machine learning algorithm may be, for example, a decision tree.

Predictive product availability model 102 may be, for example, a model to generate a predicted availability of one or more grocery product items. In various implementations, the predicted availability of one or more grocery product items may be based on a selected store location and/or a selected future delivery window. Product inventory 106 may be, for example, current product inventory for the selected store location as well as historical product inventory information for the selected store location.

FIG. 1B illustrates a grocery delivery order platform 110 according to some example implementations. In one implementation, an end user 112 may submit requests 114 to and receive responses 116 from the grocery delivery order platform 110. Requests 114 and responses 116 may represent, for example, the end user 112 interacting with the grocery delivery order platform 110 in order to place an order for grocery product items for delivery during a future delivery window from a shopping location. The future delivery window may be, for example, a future date and time during which ordered grocery product items will be delivered. For example, if the end user 112 places an order Monday afternoon, the future delivery window may be Wednesday between 6 pm-8 pm. In another example, if the end user 112 places an order Tuesday morning, the future delivery window may be Tuesday between 2 pm-4 pm. That is, while the future delivery window may be for a different later date and time, the future delivery window may be for a later time on the same date.

In various implementations, grocery delivery order platform 110 may utilize predictive product availability model 102. For example, grocery delivery order platform 110 may utilize predictive product availability model 102 to generate a predicted availability for one or more grocery product items for the shopping location during the future delivery window. If the predicted availability, in this example, exceeds a threshold, the one or more grocery product items may be presented to end user 112 for selection as part of the customer's order. If the predicted availability, in this example, does not exceed the threshold the one or more grocery product items may not be presented to end user 112. In a further example, if the predicted availability does not exceed the threshold, grocery delivery order platform 110 may generate one or more alternative shopping locations and/or one or more alternative future delivery windows for selection by end user 112.

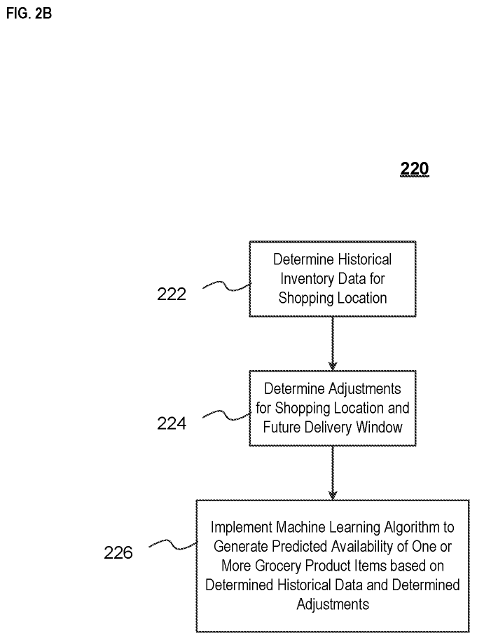

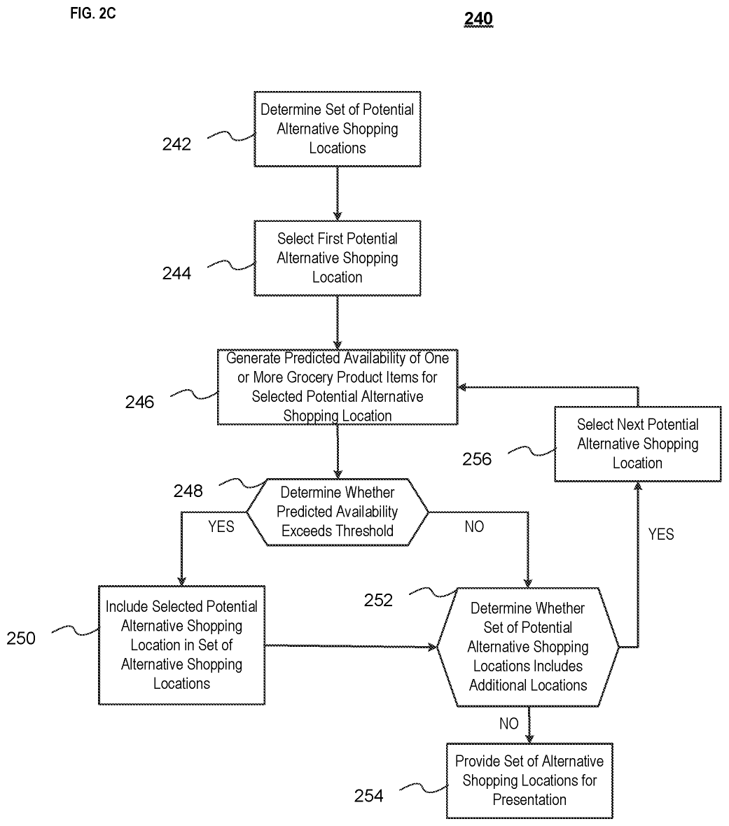

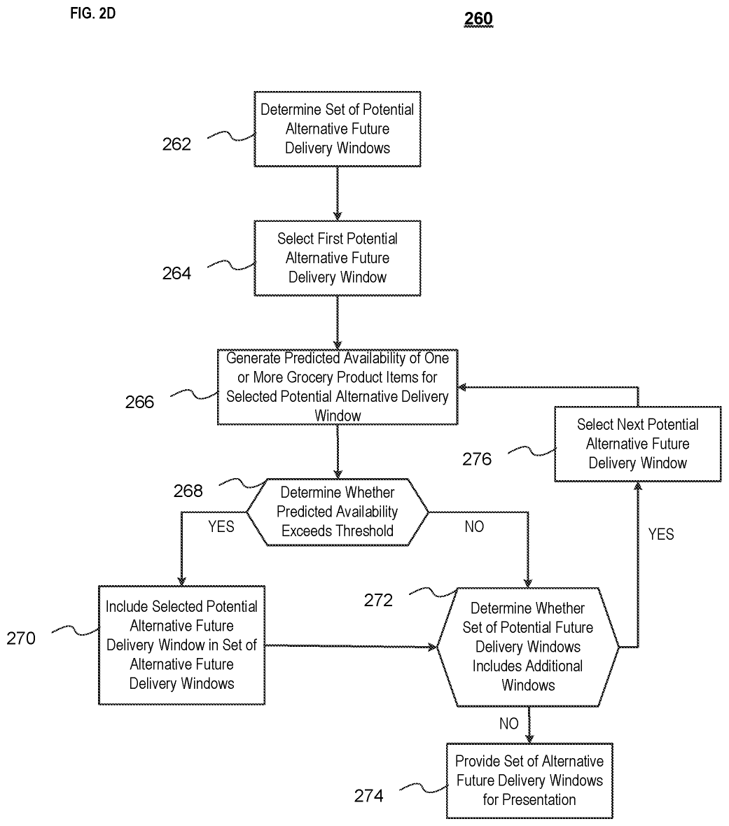

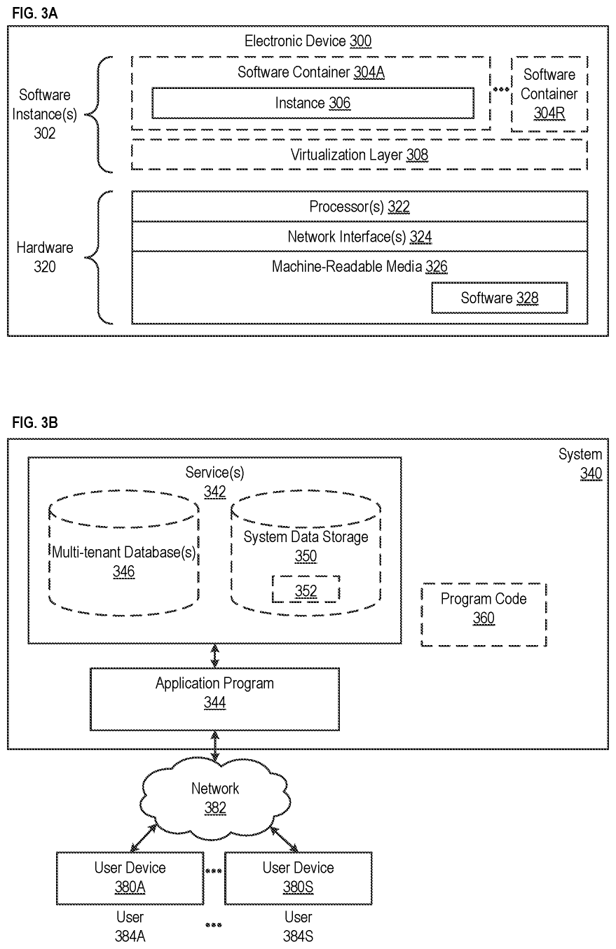

FIG. 2A illustrates a method 200 for use with predictive product availability for grocery delivery, as disclosed herein. The method 200 may be performed as part of an online shopping portal, such as grocery delivery order platform 110 of FIG. 1B. In various implementations, the steps of method 200 may be performed by a server, such as electronic device 300 of FIG. 3A or system 340 of FIG. 3B. Alternatively, or in addition, some or all of the steps may be performed by a user device, such as user device 380A of FIG. 3B. Although the steps of method 200 are presented in a particular order, this is only for simplicity.

In step 202, a shopping location may be determined. For example, a customer may select a shopping location. The customer selection may be based on proximity to the customer and/or customer preference. Alternatively, or in addition, the shopping location may be determined by an online shopping portal, such as grocery delivery order platform 110 of FIG. 1B. The online shopping portal may, for example, be selected based on proximity between the shopping location and a customer of the online shopping portal or based on preferences of the customer. In various implementations, the shopping location may be selected from one or more alternative shopping locations based on a generated predicted availability of one or more grocery product items at each of the one or more alternative shopping locations. In various implementations, the shopping location and/or the one or more alternative shopping locations may be generated by a predictive model, such as predictive product availability model 102 of FIG. 1A.

In step 204, a future delivery window may be determined. For example, a customer may select a future delivery window and such selection may be based on customer convenience and/or availability. Alternatively, or in addition, the future delivery window may be selected by an online shopping portal, such as grocery delivery order platform 110 of FIG. 1B. The online shopping portal may select the future delivery window based on a set of predetermined rules or other criteria. In various implementations, the future delivery window may be selected from one or more alternative future delivery windows based on a generated predicted availability of one or more grocery product items during each of the one or more alternative future delivery windows. In various implementations, the future delivery window and/or the one or more alternative future delivery windows may be generated by a predictive model, such as predictive product availability model 102 of FIG. 1A.

In step 206, a predicted availability of one or more grocery product items may be generated. In various implementations, the predicted availability of one or more grocery product items may be generated by an online shopping portal, such as grocery delivery order platform 110 of FIG. 1B. The predicted availability may be generated, for example, based on the determined shopping location, the determined future delivery window, and/or one or more additional criteria. In one example, the predicted availability may be generated, at least in part, by determining historical inventory data (e.g., past inventory for the determined shopping location), historical user preference data corresponding to a user, such as the customer of the online shopping portal, and one or more grocery product order factors, such as a day of the week corresponding to the future delivery window, a time of day corresponding to the future delivery window, a month of the year corresponding to the future delivery window, a season corresponding to the future delivery window, one or more scheduling factors corresponding to the shopping location, and/or other factors influencing grocery product item availability. In various implementations, the predicted availability may be generated by a predictive model, such as predictive product availability model 102 of FIG. 1A.

Alternatively, or in addition, the predicted availability may be generated, for example, based on predetermined or otherwise precalculated predicted availability. For example, a current predicted product availability may be determined at a regular interval, such as hourly. That is, at each interval (e.g., an hour) a current predicted product availability may be determined or otherwise calculated for various time periods (e.g., each hour over the next 7 days) for any of one or more shopping locations. In turn, the predicted availability may be generated, for example, based at least in part by referencing or otherwise looking up a corresponding current predicted product availability.

In step 208, the online shopping portal, for example, may determine whether the predicted availability exceeds a threshold. The threshold may be, for example, a minimum product quantity for the shopping location. That is, the online shopping portal may determine whether a shopping location is predicted to have a sufficient quantity of the one or more grocery product items during the future delivery window.

If the predicted availability is determined to exceed the threshold (i.e., step 208 is “YES”), the method may proceed to step 210. In step 210, the one or more grocery product items may be presented to the customer for selection as part of the customer's order. For example, as the customer utilizes the online shopping portal to create an order, the customer may only see the one or more grocery product items for which the predicted availability exceeds the threshold.

If the predicted availability is determined to not exceed the threshold (i.e., step 208 is “NO”), the method may proceed to optional step 212. The online shopping portal, in optional step 210, may present one or more alternative shopping locations for selection by the customer. In various implementations, the one or more alternative shopping locations may be generated by a predictive model, such as predictive product availability model 102 of FIG. 1A.

In option step 214, the online shopping portal, for example, may present one or more alternative future delivery windows for selection by the customer. In various implementations, the one or more alternative future delivery windows may be generated by a predictive model, such as predictive product availability model 102 of FIG. 1A.

FIG. 2B illustrates a method 220 of generating predicted availability of grocery product items, as disclosed herein. The method 220 may be performed as part of step 206 of method 200. That is, method 220 may, for example, generate a predicted availability of one or more grocery product items. Although the steps of method 220 are depicted in a particular order, this is only for simplicity. In various implementations, method 220 may be performed by an online shopping portal, such as grocery delivery order platform 110 of FIG. 1B. In various implementations, method 220 may be performed as part of a predictive model, such as predictive product availability model 102 of FIG. 1A.

In step 222, a predictive model, for example, may determine historical inventory data for a shopping location. For example, the predictive model may reference or otherwise retrieve historical inventory data from an inventory system operated by or on behalf of the shopping location.

In step 224, the predictive model, for example, may determine adjustments for the shopping location and/or a future delivery window. In various implementations, the determined adjustments may be based on one or more grocery product order factors, such as a day of the week corresponding to the future delivery window, a time of day corresponding to the future delivery window, a month of the year corresponding to the future delivery window, a season corresponding to the future delivery window, one or more scheduling factors corresponding to the shopping location, and/or other factors influencing grocery product item availability. For example, the shopping location may be a store that specializes in farm fresh produce while the future delivery window may be during a winter month. In this example, these factors (i.e., farm fresh produce and winter month) may result in adjustments that negatively impact predicted availability for farm fresh produce at the shopping location.

In step 226, the predictive model, for example, may implement a machine learning algorithm to generate a predicted availability of one or more grocery product items based, at least in part, on the determined historical data and the determined adjustments. In various implementations, the machine learning algorithm may be a decision tree.

FIG. 2C illustrates a method 240 of generating alternative shopping locations, as disclosed herein. The method 240 may be performed as part of step 212 of method 200. That is, method 240 may, for example, generate one or more alternative shopping locations for presentation to a customer. Although the steps of method 240 are depicted in a particular order, this is only for simplicity. In various implementations, method 240 may be performed by an online shopping portal, such as grocery delivery order platform 110 of FIG. 1B. In various implementations, method 240 may be performed as part of a predictive model, such as predictive product availability model 102 of FIG. 1A.

In step 242, a predictive model, for example, may determine a set of potential alternative shopping locations. In various implementations, the predictive model may use a number of different factors to determine the set of potential alternative shopping locations, such as proximity to customer, hours of operation, customer preference, etc. For example, the predictive model may identify all shopping locations within a 15 mile radius of the location of a customer. In a further example, the predictive model may limit the set of potential alternative shopping locations to those shopping locations of a customer preferred brand.

In step 244, the predictive model, for example, may select a first potential alternative shopping location from the set of potential alternative shopping locations. In some implementations, the selection may be random or pseudo-random in nature. In other implementations, the set of potential alternative shopping locations may be rank ordered and the first potential alternative may be selected based on rank. In these other implementations, the rank order may be determined based on a number of factors, such as proximity to the customer, hours of operation, customer preference, pricing criteria, etc. In various implementations, when the first potential alternative shopping location is selected, the selected alternative shopping location may be removed from the set of potential alternative shopping locations.

In step 246, the predictive model, for example, may generate a predicted availability of one or more grocery product items for the selected potential alternative shopping location. In various implementations, the predicted availability may be generated based on a machine learning algorithm. The machine learning algorithm may be, for example, a decision tree.

In step 248, the predictive model, for example, may determine whether the predicted availability of the one or more grocery product items for the selected potential alternative shopping location exceeds a threshold. That is, the predictive model may determine whether the selected potential alternative shopping location is predicted to have a large enough quantity of the one or more grocery product items during a future delivery window.

If the predicted availability of the one or more grocery product items for the selected potential alternative shopping location exceeds a threshold (i.e., step 248=“YES”), the selected potential alternative shopping location may be included in a set of alternative shopping locations in step 250. Method 240 then moves to step 252.

If the predicted availability of the one or more grocery product items for the selected potential alternative shopping location does not exceed a threshold (i.e., step 248=“NO”), method 240 then moves to step 252.

In step 252, the predictive model, for example, may determine whether the set of potential alternative shopping locations includes any additional potential alternative shopping locations.

If the set of potential alternative shopping locations does not include any additional potential alternative shopping locations (i.e., step 252=“NO”), the predictive model, for example, may provide the set of alternative shopping locations for presentation to a customer in step 254.

If the set of potential alternative shopping locations does include an additional potential alternative shopping location (i.e., step 252=“YES”), the predictive model, for example, may select the next potential alternative shopping location in step 256. That is, if there is still one or more potential alternative shopping locations for which a predicted availability may be generated, another potential alternative shopping location is selected. Method 240 then returns to step 246 where a predicted availability is generated for the next potential alternative shopping location.

FIG. 2D illustrates a method 260 of generating alternative future delivery windows, as disclosed herein. The method 260 may be performed as part of step 214 of method 200. That is, method 260 may, for example, generate one or more alternative future delivery windows for presentation to a customer. Although the steps of method 260 are depicted in a particular order, this is only for simplicity. In various implementations, method 260 may be performed by an online shopping portal, such as grocery delivery order platform 110 of FIG. 1B. In various implementations, method 260 may be performed as part of a predictive model, such as predictive product availability model 102 of FIG. 1A.

In step 262, a predictive model, for example, may determine a set of potential alternative future delivery windows. In various implementations, the predictive model may use a number of different factors to determine the set of potential alternative future delivery windows, such as hours of operation of a corresponding shopping location, customer preference, etc.

In step 264, the predictive model, for example, may select a first potential alternative future delivery window from the set of potential alternative future delivery windows. In some implementations, the selection may be random or pseudo-random in nature. In other implementations, the set of potential alternative future delivery windows may be rank ordered and the first potential alternative may be selected based on rank. In these other implementations, the rank order may be determined based on a number of factors, such as hours of operation of a corresponding shopping location, customer preference, pricing criteria, etc. In various implementations, when the first potential alternative future delivery window is selected, the selected alternative future delivery window may be removed from the set of potential alternative future delivery windows.

In step 266, the predictive model, for example, may generate a predicted availability of one or more grocery product items for the selected potential alternative future delivery window. In various implementations, the predicted availability may be generated based on a machine learning algorithm. The machine learning algorithm may be, for example, a decision tree.

In step 268, the predictive model, for example, may determine whether the predicted availability of the one or more grocery product items for the selected potential alternative future delivery window exceeds a threshold.

If the predicted availability of the one or more grocery product items for the selected potential alternative future delivery window exceeds a threshold (i.e., step 268=“YES”), the selected potential alternative future delivery window may be included in a set of alternative future delivery windows in step 270. Method 260 then moves to step 272.

If the predicted availability of the one or more grocery product items for the selected potential alternative future delivery window does not exceed a threshold (i.e., step 268=“NO”), method 260 then moves to step 272.

In step 272, the predictive model, for example, may determine whether the set of potential alternative future delivery windows includes any additional potential alternative future delivery windows.

If the set of potential alternative future delivery windows does not include any additional potential alternative future delivery window (i.e., step 272=“NO”), the predictive model, for example, may provide the set of alternative future delivery windows for presentation to a customer in step 274.

If the set of potential alternative future delivery windows does include an additional potential alternative future delivery window (i.e., step 272=“YES”), the predictive model, for example, may select the next potential alternative future delivery window in step 276. That is, if there is still one or more potential alternative future delivery windows for which a predicted availability may be generated, another potential alternative future delivery window is selected. Method 260 then returns to step 266 where a predicted availability is generated for the next potential alternative future delivery window.

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals—such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

FIG. 3A is a block diagram illustrating an electronic device 300 according to some example implementations. FIG. 3A includes hardware 320 comprising a set of one or more processor(s) 322, a set of one or more network interfaces 324 (wireless and/or wired), and machine-readable media 326 having stored therein software 328 (which includes instructions executable by the set of one or more processor(s) 322). The machine-readable media 326 may include non-transitory and/or transitory machine-readable media. Each of the previously described clients and the predictive product availability for grocery delivery service may be implemented in one or more electronic devices 300. In one implementation: 1) each of the clients is implemented in a separate one of the electronic devices 300 (e.g., in end user devices where the software 328 represents the software to implement clients to interface directly and/or indirectly with the predictive product availability for grocery delivery service (e.g., software 328 represents a web browser, a native client, a portal, a command-line interface, and/or an application programming interface (API) based upon protocols such as Simple Object Access Protocol (SOAP), Representational State Transfer (REST), etc.)); 2) the predictive product availability for grocery delivery service is implemented in a separate set of one or more of the electronic devices 300 (e.g., a set of one or more server devices where the software 328 represents the software to implement the predictive product availability for grocery delivery service); and 3) in operation, the electronic devices implementing the clients and the predictive product availability for grocery delivery service would be communicatively coupled (e.g., by a network) and would establish between them (or through one or more other layers and/or other services) connections for submitting requests to the predictive product availability for grocery delivery service and returning responses to the clients. Other configurations of electronic devices may be used in other implementations (e.g., an implementation in which the client and the predictive product availability for grocery delivery service are implemented on a single one of electronic device 300).

During operation, an instance of the software 328 (illustrated as instance 306 and referred to as a software instance; and in the more specific case of an application, as an application instance) is executed. In electronic devices that use compute virtualization, the set of one or more processor(s) 322 typically execute software to instantiate a virtualization layer 308 and one or more software container(s) 304A-304R (e.g., with operating system-level virtualization, the virtualization layer 308 may represent a container engine (such as Docker Engine by Docker, Inc. or rkt in Container Linux by Red Hat, Inc.) running on top of (or integrated into) an operating system, and it allows for the creation of multiple software containers 304A-304R (representing separate user space instances and also called virtualization engines, virtual private servers, or jails) that may each be used to execute a set of one or more applications; with full virtualization, the virtualization layer 308 represents a hypervisor (sometimes referred to as a virtual machine monitor (VMM)) or a hypervisor executing on top of a host operating system, and the software containers 304A-304R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 328 is executed within the software container 304A on the virtualization layer 308. In electronic devices where compute virtualization is not used, the instance 306 on top of a host operating system is executed on the “bare metal” electronic device 300. The instantiation of the instance 306, as well as the virtualization layer 308 and software containers 304A-304R if implemented, are collectively referred to as software instance(s) 302.

Alternative implementations of an electronic device may have numerous variations from that described above. For example, customized hardware and/or accelerators might also be used in an electronic device.

FIG. 3B is a block diagram of a deployment environment according to some example implementations. A system 340 includes hardware (e.g., a set of one or more server devices) and software to provide service(s) 342, including the XYZ service. In some implementations the system 340 is in one or more datacenter(s). These datacenter(s) may be: 1) first party datacenter(s), which are datacenter(s) owned and/or operated by the same entity that provides and/or operates some or all of the software that provides the service(s) 342; and/or 2) third-party datacenter(s), which are datacenter(s) owned and/or operated by one or more different entities than the entity that provides the service(s) 342 (e.g., the different entities may host some or all of the software provided and/or operated by the entity that provides the service(s) 342). For example, third-party datacenters may be owned and/or operated by entities providing public cloud services.

The system 340 is coupled to user devices 380A-380S over a network 382. The service(s) 342 may be on-demand services that are made available to one or more of the users 384A-384S working for one or more entities other than the entity which owns and/or operates the on-demand services (those users sometimes referred to as outside users) so that those entities need not be concerned with building and/or maintaining a system, but instead may make use of the service(s) 342 when needed (e.g., when needed by the users 384A-384S). The service(s) 342 may communicate with each other and/or with one or more of the user devices 380A-380S via one or more APIs (e.g., a REST API). In some implementations, the user devices 380A-380S are operated by users 384A-384S, and each may be operated as a client device and/or a server device. In some implementations, one or more of the user devices 380A-380S are separate ones of the electronic device 300 or include one or more features of the electronic device 300.

In some implementations, the system 340 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants.

In one implementation, the system 340 is a multi-tenant cloud computing architecture supporting multiple services, such as one or more of the following types of services: Customer relationship management (CRM); Configure, price, quote (CPQ); Business process modeling (BPM); Customer support; Marketing; Predictive Product Availability for Grocery Delivery; External data connectivity; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“app store”); Data modeling; Security; and Identity and access management (IAM).

For example, system 340 may include an application platform 344 that enables PAAS for creating, managing, and executing one or more applications developed by the provider of the application platform 344, users accessing the system 340 via one or more of user devices 380A-380S, or third-party application developers accessing the system 340 via one or more of user devices 380A-380S.

In some implementations, one or more of the service(s) 342 may use one or more multi-tenant databases 346, as well as system data storage 350 for system data 352 accessible to system 340. In certain implementations, the system 340 includes a set of one or more servers that are running on server electronic devices and that are configured to handle requests for any authorized user associated with any tenant (there is no server affinity for a user and/or tenant to a specific server). The user devices 380A-380S communicate with the server(s) of system 340 to request and update tenant-level data and system-level data hosted by system 340, and in response the system 340 (e.g., one or more servers in system 340) automatically may generate one or more Structured Query Language (SQL) statements (e.g., one or more SQL queries) that are designed to access the desired information from the multi-tenant database(s) 346 and/or system data storage 350.

In some implementations, the service(s) 342 are implemented using virtual applications dynamically created at run time responsive to queries from the user devices 380A-380S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 360 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 344 includes an application setup mechanism that supports application developers' creation and management of applications, which may be saved as metadata by save routines. Invocations to such applications, including the XYZ service, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 382 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4^{th} generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 340 and the user devices 380A-380S.

Each user device 380A-380S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 340. For example, the user interface device can be used to access data and applications hosted by system 340, and to perform searches on stored data, and otherwise allow one or more of users 384A-384S to interact with various GUI pages that may be presented to the one or more of users 384A-384S. User devices 380A-380S might communicate with system 340 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 380A-380S might include an HTTP client, commonly referred to as a “browser,” for sending and receiving HTTP messages to and from server(s) of system 340, thus allowing users 384A-384S of the user devices 380A-380S to access, process and view information, pages and applications available to it from system 340 over network 382.

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting.

What is claimed is:

1. A computer-implemented method comprising:
determining, at a server, a shopping location from which a grocery product order will be fulfilled;
determining, at the server, a future delivery window during which the grocery product order will be fulfilled;
generating a predicted availability of one or more grocery product items at the shopping location during the future delivery window by determining, at the server:
historical inventory data;
historical user preference data corresponding to a user; and
one or more grocery product order factors selected from the group consisting of:
a day of the week corresponding to the future delivery window;
a time of day corresponding to the future delivery window;
a month of the year corresponding to the future delivery window;
a season corresponding to the future delivery window; and
one or more scheduling factors corresponding to the shopping location; and
based upon the shopping location, the future delivery window, and the predicted availability of the one or more grocery product items, presenting a fulfillable order option to the user.

2. The computer-implemented method of claim 1, wherein generating the predicted availability of the one or more grocery product items further comprises implementing a machine learning algorithm to generate the predicted availability.

3. The computer-implemented method of claim 1, wherein presenting the fulfillable order option to the user comprises:
determining the predicted availability of the one or more grocery product items exceeds a threshold; and
presenting the one or more grocery product items for selection by the user.

4. The computer-implemented method of claim 1, wherein presenting the fulfillable order option to the user comprises:
determining the predicted availability of the one or more grocery product items does not exceed a threshold; and
presenting one or more alternative shopping locations for selection by the user.

5. The computer-implemented method of claim 4, wherein presenting one or more alternative shopping locations further comprises implementing a machine learning algorithm to generate the one or more alternative shopping locations.

6. The computer-implemented method of claim 1, wherein presenting the fulfillable order option to the user comprises:
determining the predicted availability of the one or more grocery product items does not exceed a threshold; and
presenting one or more alternative future delivery windows for selection by the user.

7. The computer-implemented method of claim 6, wherein presenting one or more alternative future delivery windows further comprises implementing a machine learning algorithm to generate the one or more alternative future delivery windows.

8. A non-transitory machine-readable storage medium that provides instructions that, if executed by a processor, are configurable to cause said processor to perform operations comprising:
determining, at a server, a shopping location from which a grocery product order will be fulfilled;
determining, at the server, a future delivery window during which the grocery product order will be fulfilled;
generating a predicted availability of one or more grocery product items at the shopping location during the future delivery window by determining, at the server:
historical inventory data;
historical user preference data corresponding to a user; and
one or more grocery product order factors selected from the group consisting of:
a day of the week corresponding to the future delivery window;
a time of day corresponding to the future delivery window;
a month of the year corresponding to the future delivery window;
a season corresponding to the future delivery window; and
one or more scheduling factors corresponding to the shopping location; and
based upon the shopping location, the future delivery window, and the predicted availability of the one or more grocery product items, presenting a fulfillable order option to the user.

9. The non-transitory machine-readable storage medium of claim 8, wherein generating the predicted availability of the one or more grocery product items further comprises implementing a machine learning algorithm to generate the predicted availability.

10. The non-transitory machine-readable storage medium of claim 8, wherein presenting the fulfillable order option to the user comprises:
determining the predicted availability of the one or more grocery product items exceeds a threshold; and
presenting the one or more grocery product items for selection by the user.

11. The non-transitory machine-readable storage medium of claim 8, wherein presenting the fulfillable order option to the user comprises:
determining the predicted availability of the one or more grocery product items does not exceed a threshold; and
presenting one or more alternative shopping locations for selection by the user.

12. The non-transitory machine-readable storage medium of claim 11, wherein presenting one or more alternative shopping locations further comprises implementing a machine learning algorithm to generate the one or more alternative shopping locations.

13. The non-transitory machine-readable storage medium of claim 8, wherein presenting the fulfillable order option to the user comprises:
determining the predicted availability of the one or more grocery product items does not exceed a threshold; and
presenting one or more alternative future delivery windows for selection by the user.

14. The non-transitory machine-readable storage medium of claim 13, wherein presenting one or more alternative future delivery windows further comprises implementing a machine learning algorithm to generate the one or more alternative future delivery windows.

15. An apparatus comprising:
a processor;
a non-transitory machine-readable storage medium that provides instructions that, if executed by the processor, are configurable to cause the apparatus to perform operations comprising,
determining, at a server, a shopping location from which a grocery product order will be fulfilled;
determining, at the server, a future delivery window during which the grocery product order will be fulfilled;
generating a predicted availability of one or more grocery product items at the shopping location during the future delivery window by determining, at the server:
historical inventory data;
historical user preference data corresponding to a user; and
one or more grocery product order factors selected from the group consisting of:
a day of the week corresponding to the future delivery window;
a time of day corresponding to the future delivery window;
a month of the year corresponding to the future delivery window;
a season corresponding to the future delivery window; and
one or more scheduling factors corresponding to the shopping location; and
based upon the shopping location, the future delivery window, and the predicted availability of the one or more grocery product items, presenting a fulfillable order option to the user.

16. The apparatus of claim 15, wherein generating the predicted availability of the one or more grocery product items further comprises implementing a machine learning algorithm to generate the predicted availability.

17. The apparatus of claim 15, wherein presenting the fulfillable order option to the user comprises:
determining the predicted availability of the one or more grocery product items exceeds a threshold; and
presenting the one or more grocery product items for selection by the user.

18. The apparatus of claim 15, wherein presenting the fulfillable order option to the user comprises:
determining the predicted availability of the one or more grocery product items does not exceed a threshold; and
presenting one or more alternative shopping locations for selection by the user.

19. The apparatus of claim 15, wherein presenting the fulfillable order option to the user comprises:
determining the predicted availability of the one or more grocery product items does not exceed a threshold; and
presenting one or more alternative future delivery windows for selection by the user.
